(19) United States
(12) Patent Application Publication
(10) Pub. No.: US 2021/0332252 A1
(43) Pub. Date: Oct. 28, 2021

(54) STAIN RESISTANT COATING

(71) Applicant: NOURYON CHEMICALS INTERNATIONAL B.V., ARNHEM (NL)

(72) Inventors: Peter Harry Johan GREENWOOD, Göteborg (SE); Per Anders RESTORP, Sävedalen (SE)

(73) Assignee: NOURYON CHEMICALS INTERNATIONAL B.V., ARNHEM (NL)

(21) Appl. No.: 17/305,521

(22) Filed: Jul. 9, 2021

(30) Foreign Application Priority Data
Jan. 11, 2019 (EP) 19151311.8

(51) Int. Cl. C09D 7/62; C09D 7/65; C09D 5/02; C08K 3/36; C08K 9/06; C08L 23/08; C08L 29/04; C08K 5/14; C08K 5/23

(52) U.S. Cl. CPC C09D 7/62; C09D 7/65; C09D 5/024; C08K 3/36; C08L 2201/54; C08L 23/0853; C08L 29/04; C08K 5/14; C08K 5/23; C08K 9/06

(57) ABSTRACT

The present disclosure relates to a method for preparing a coating composition, in which an aqueous phase comprising an organosilane-functionalised colloidal silica is mixed with an organic phase comprising one or more monomers in the presence of an initiator and a protective colloid, wherein conditions are maintained such that polymerisation of the one or more monomers occurs to form an aqueous polymeric dispersion, in which the aqueous polymeric dispersion comprises polymer particles with protective colloid on their surface; the organosilane-functionalised colloidal silica comprises colloidal silica particles with at least one surface-bound organosilane moiety; and the initiator is at least partially soluble in water.

### CROSS-REFERENCE TO RELATED APPLICATION

This application is a U.S. National-Stage entry under 35 U.S.C. § 371 based on International Application No. PCT/EP2020/050593, filed Jan. 10, 2020 which was published under PCT Article 21(2) and which claims priority to European Application No. 19151311.8, filed Jan. 11, 2019, which are all hereby incorporated in their entirety by reference.

### TECHNICAL FIELD

This present disclosure relates to coating composition that has stain resistance. The present disclosure also relates to the use of organosilane-functionalised colloidal silica to improve stain resistance in coatings. The present disclosure further relates to a method of making a stain-resistant coating composition.

### BACKGROUND

Colloidal silica compositions are known additives in coating compositions, and can improve properties such as adhesion to the substrate and increased wear and water resistance, to improved open times, to improved thermal stability, to improved barrier properties and to improved dirt pick-up resistance (see for example WO 2004/035474, WO 2012/130763, WO 2013/167501, WO 2014/005753 and US 2007/0292683).

A desirable property of coatings, particularly paint compositions, is that of stain resistance, i.e. the ability to avoid staining when contacted with materials such as coffee, food, grease etc. This is a distinct property compared to dirt pick-up resistance. Dirt pick-up resistance is a test of the extent to which solid particulate contaminants (e.g. carbon black or iron oxide dust) adhere to the coating's surface. Stain resistance is a measure of resistance to permanent staining, which additionally accounts for factors such as absorption or dissolution of contaminants into the polymeric or resinous component of the coating. Thus, a dirt resistant coating is not necessarily a stain-resistant coating.

The aim of the present disclosure is, therefore, to find a way to improve stain resistance of coatings.

### BRIEF SUMMARY

This disclosure provides a method for preparing a coating composition, in which an aqueous phase comprising an organosilane-functionalised colloidal silica is mixed with an organic phase comprising one or more monomers in the presence of an initiator and a protective colloid, wherein conditions are maintained such that polymerisation of the one or more monomers occurs to form an aqueous polymeric dispersion, in which;
(i) the aqueous polymeric dispersion comprises polymer particles with protective colloid on their surface;
(ii) the organosilane-functionalised colloidal silica comprises colloidal silica particles with at least one surface-bound organosilane moiety; and
(iii) the initiator is at least partially soluble in water.

This disclosure also provides a coating composition comprising an aqueous polymeric dispersion and organosilane-functionalised colloidal silica particles, in which;
(i) the aqueous polymeric dispersion comprises polymer particles with protective colloid on their surface;
(ii) the organosilane-functionalised colloidal silica comprises colloidal silica particles with at least one surface-bound organosilane moiety; and
(iii) at least a portion of the colloidal silica particles chemically interact with the protective colloid.

### BRIEF DESCRIPTION OF DRAWINGS

The present disclosure will hereinafter be described in conjunction with the following FIGURE, wherein:

FIG. 1 is a photograph of a coated glass plate to which various staining contaminants have been applied.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

In one embodiment, the present disclosure is directed to a method for preparing a coating composition, in which an aqueous phase comprising an organosilane-functionalised colloidal silica is mixed with an organic phase comprising one or more monomers in the presence of an initiator and a protective colloid, wherein conditions are maintained such that polymerisation of the one or more monomers occurs to form an aqueous polymeric dispersion or emulsion, in which;
(i) the aqueous polymeric dispersion or emulsion comprises polymer particles with protective colloid on their surface;
(ii) the organosilane-functionalised colloidal silica comprises colloidal silica particles with at least one surface-bound organosilane moiety; and
(iii) the initiator is at least partially soluble in water.

In another embodiment, the present disclosure is also to a coating composition comprising an aqueous polymeric dispersion or emulsion and organosilane-functionalised colloidal silica particles, in which;
(i) the aqueous polymeric dispersion or emulsion comprises polymer particles with protective colloid on their surface;
(ii) the organosilane-functionalised colloidal silica comprises colloidal silica particles with at least one surface-bound organosilane moiety; and
(iii) at least a portion of the colloidal silica particles chemically interact with the protective colloid.

In another embodiment, the present disclosure is directed the use of organosilane-functionalised colloidal silica particles for improving the stain resistance of a coating.

The present disclosure relates to latex-based (aqueous polymer dispersion or emulsion-based) coating compositions, and a method for their production which enables the resulting product to have improved properties.

The method involves polymerisation of a monomer or mixture of monomers under conditions such that an aqueous polymer dispersion or emulsion (e.g. latex) results. The polymer dispersion is stabilised with a protective colloid. In this disclosure, unless specified otherwise, the term “polymer dispersion” or “dispersion of polymer” is intended to encompass dispersions of solid polymer particles in a liquid, and also emulsions where the dispersed polymer is in a liquid form, for example where the temperature of the composition is higher than the Tg of the polymer, such as in high temperature environments and/or low Tg polymers.

In embodiments, the reaction mixture can initially comprise an emulsion of a monomer-containing organic phase in an aqueous continuous phase. The monomer is then polymerised in the presence of initiator, which forms a dispersion of polymer in a continuous aqueous phase. The aqueous phase comprises the water-miscible components, such as initiator, organosilane-functionalised colloidal silica, and protective colloid stabiliser. Although organic solvents can be present in this aqueous phase (for example C1-4 alcohols, ketones, carboxylic acids or glycols), they are maintained at concentrations below that which would disrupt the formation of an emulsion or dispersion of the organic phase. Therefore, if present, they comprise no more than about 10 wt % of the aqueous phase, and typically no more than about 5 wt %.

### [Monomers]

In the present disclosure, the monomer, or at least one monomer is selected from alkenyl carboxylate ester-based monomers, acrylate-based monomers and styrene-based monomers. Where a mixture of monomers is used, there can also be one or more further alkenyl carboxylate ester-, acrylate-, or styrene-based monomer, and/or one or more diene monomers. Where a styrene-based monomer is used, a diene co-monomer is also typically used.

Typically, the monomer, or at least one monomer, is an alkenyl carboxylate ester-based monomer.

In embodiments, the monomers that are suitable for use can have a chemical formula according to Formula 1:

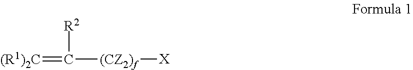

R1 and R2 on each occurrence are independently selected from H, halide and C1-20 alkyl. Each C1-20 group can optionally be substituted with one or more groups selected from hydroxyl, halide, oxygen (i.e. to form a C═O moiety), —OR3 and —N(R3)2. In embodiments, R1 and R2 cannot both be halide. In embodiments, the C1-20 alkyl is a C1-6 alkyl such as a C1-4alkyl or a C1-2 alkyl. Typically, at least one R1 or R2 group is H.

R3 on each occurrence is independently selected from H and optionally substituted C1-6 alkyl, where optional substituents are one or more groups selected from hydroxyl, halide, amino, C1-6 alkoxy, C1-6 alkyl-amino and C1-6 dialkyl amino. Each C1-6 group can, in embodiments, be a C1-4 group or a C1-2 group.

In the group —[CZ2]f —, each Z is independently selected from H, halide, C1-3 alkyl and C1-3 haloalkyl; and f is a whole number in the range of from about 0 to about 4, for example about 0 to about 2 or about 0 to about 1. In embodiments, the C1-3 alkyl can be methyl and the C1-3 haloalkyl can be halomethyl. In embodiments, there are no halides or haloalkyl substituents. In embodiments, f is about 0, i.e. there is a direct bond between the C—R2 group and the X group.

X is selected from:

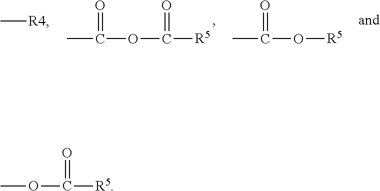

R4 on each occurrence is independently selected from C5-8 aryl and C5-8 heteroaryl groups. The aryl or heteroaryl groups can optionally be substituted with one or more groups selected from hydroxyl, halide, —N(R3)2, C1-10 alkyl, C1-10 haloalkyl, C1-10 alkoxy and C1-10 haloalkoxy. The heteroaryl group comprises one or more heteroatoms in the ring, each independently selected from O, S and N. In embodiments, the aryl or heteroaryl group is a C6 group. In embodiments, the heteroatom is N. In embodiments, the aryl group is an optionally substituted benzene ring. In embodiments, the aryl or heteroaryl group contains no halide or halide-containing substituents. In embodiments, the aryl group is unsubstituted.

When X is R4 there is typically also an additional monomer in the organic phase, for example a diene-based monomer.

R5 on each occurrence is independently selected from H, optionally substituted C1-20 alkyl and optionally substituted C1-20 alkenyl. Each C1-20 alkyl or C1-20 alkenyl group can optionally be substituted with one or more groups selected from hydroxyl, halide and —N(R3)2. In embodiments, the C1-20 alkyl or alkenyl group can be a C1-6 alkyl or alkenyl group, for example a C1-4 alkyl or alkenyl group.

In embodiments, X is selected from

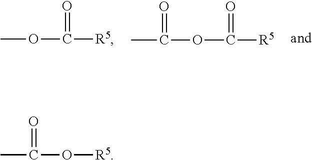

In embodiments, in such monomers, f in [CZ2]f is about 0. In embodiments R5 is selected from H and optionally substituted C1-6 alkyl, and in further embodiments the C1-6 alkyl is unsubstituted.

In embodiments, Formula 1 is halide-free, i.e. there are no substituents or optional substituents containing a halide moiety.

In embodiments, the monomer, or at least one monomer, has a formula where X is

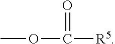

In Formula 1 above, or any of the Formulae defined below, any alkyl or alkenyl groups (whether substituted or unsubstituted) can be linear, branched or cyclic. Any halide moiety independently and on each occurrence can be selected from F, Cl, Br and I, typically F and Cl.

[Alkenyl carboxylates]

In embodiments, at least one monomer is an alkenyl carboxylate ester-based monomer. Such monomers can, in embodiments, comprise from about 4 to about 20 carbon atoms. Specific examples include vinyl formate, vinyl acetate, vinyl propionate, vinyl butyrate, vinyl pivalate, vinyl versatate (where the versatate group comprises a C4-12 branched alkyl group), vinyl stearate, vinyl laurate, vinyl-2-ethyl hexanoate, 1-methyl vinyl acetate, as well as vinyl esters of benzoic acid and p-tert-butyl benzoic acid. In embodiments, vinyl acetate, vinyl laurate and/or vinyl versatate are used for producing the polymer dispersions. In further embodiments, the monomer, or at least one monomer, is vinyl acetate.

In embodiments, such monomers can be of Formula 1 above, where X is

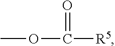

and in further embodiments they can comprise from about 4 to about 20 carbon atoms. R5 can be an optionally substituted C1-12 alkyl. In embodiments, fin [CZ2]f is about 0. In embodiments, there are no halide moieties amongst the substituents or optional substituents. In embodiments, all R1 and R2 are independently selected from hydrogen and unsubstituted C1-2 alkyl.

### [Acrylates]

In embodiments, at least one monomer is an acrylate-based monomer, for example being selected from acrylic acid, acrylic acid esters, acrylic anhydride, alkyl-acrylic acid, alkyl-acrylic acid esters, and alkyl-acrylic acid anhydrides. Such monomers can comprise, in total, from about 3 to about 20, for example from about 3 to about 13, carbon atoms. Examples include acrylic acid, methacrylic acid, methyl acrylate, n-propyl acrylate, n-butyl acrylate, iso-butyl acrylate, sec-butyl acrylate, t-butyl acrylate, n-hexyl acrylate, ethyl hexyl acrylate, isobornyl acrylate, methyl methacrylate, ethyl methacrylate, allyl methacrylate, n-butyl methacrylate, isobutyl methacrylate, tert-butyl methacrylate, n-hexyl methacrylate, isobornyl methacrylate, acrylic anhydride, methacrylic anhydride, 2-hydroxyethyl acrylate, 2-hydroxyethyl methacrylate, hydroxypropyl acrylate, hydroxypropylmethacrylate; propylene glycol methacrylate, butanediol monoacrylate, dimethylaminoethyl methacrylate, diethylaminoethyl acrylate and tert-butylaminoethyl methacrylate.

In embodiments, such monomers are of Formula 1, where X is

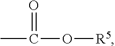

and the monomer in embodiments comprise from about 3 to about 20 carbon atoms.

In other embodiments, X is

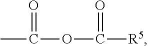

and the monomer in embodiments can comprise from about 4 to about 20 carbon atoms. In embodiments, f in [CZ2]f is about 0.

In embodiments, there are no halide moieties amongst the substituents or optional substituents. In further embodiments, all of R1 and R2 are independently selected from H and optionally substituted C1-10 alkyl, and R5 is selected from optionally substituted C1-10 alkyl and C1-10 alkenyl. In embodiments, all of R1 and R2 are independently selected from H and unsubstituted C1-6 alkyl, with all R1 in embodiments being H and R2 being selected from H and unsubstituted C1-2 alkyl.

### [Styrenes and Dienes]

In embodiments, at least one monomer is a styrene-based monomer, for example being selected from styrene and substituted styrenes, typically comprising in the range of from about 8 to about 12 carbon atoms.

In embodiments, the styrene-based monomer is of Formula 1, where X is R4.

In embodiments, R1 and R2 are selected from H, halide, and optionally substituted C1-6 alkyl. In embodiments, R4 is an optionally substituted benzene ring. In embodiments, f in [CZ2]f is about 0 or about 1, and in further embodiments it is about 0.

Styrene-based monomers are typically copolymerised with a diene monomer, i.e. monomers comprising two or more double bonds, which in embodiments can comprise from about 4 to about 15 carbon atoms, for example from about 4 to about 10 or from about 4 to about 6 carbon atoms. Examples include 1,3-butadiene and isoprene.

The diene-based monomer can be selected from those of Formula 2:

(R¹)₂C═CR¹—CR¹═C(R¹)₂ Formula 2

In embodiments, the Formula 2 can comprise from about 4 to about 15 carbon atoms. In embodiments, no more than two R1 substituents are halide, and in further embodiments, no R1 substituents are halide or contain any halide. In still further embodiments, at least four R1 substituents are H, and in other embodiments all R1 are H. In still further embodiments, all R1 are selected from H and C1-10 alkyl and C1-10 alkenyl, for example all R1 can be selected from H and C1-5 alkyl. In embodiments, the diene-based monomer is halide-free, i.e. no substituents or optional substituents contain any halide moiety.

### [Other Co-Monomers]

At least one monomer can be of Formula 1. Where a mixture of monomers is used, there can also be one or more further monomers of Formula 1 and/or one or more monomers of Formula 2, and or one or more other co-monomers.

Examples of other co-monomers include those defined in (i) to (xv) below:

(i) C1-20 mono-olefins (e.g. C1-8 or C1-4 mono-olefins), optionally halo-substituted, for example ethene, propene, 1-butene, 2-butene, vinyl chloride and vinylidene chloride.
(ii) Glycol acrylates or glycol esters of alkenyl carboxylates, such as those of formula 3:

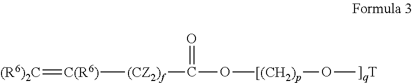

where p is a whole number from about 1 to about 3, q is a whole number from about 1 to about 10, T is H or unsubstituted C1-3 alkyl, and each R6 is independently selected from H, C1-10 alkyl, C1-10 haloalkyl and OR3. In glycol acrylates, f is [CZ2]f is about zero. In glycol esters of alkenyl carboxylates, f is greater than about zero. An example of a glycol acrylate monomer is ethyldiglycol acrylate.
(iii) Sulfonate group-containing monomers, such as those of Formula 4:

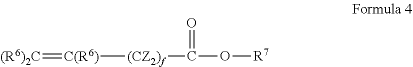

where R7 is —|C(R6)2|p-SO3H or —N(R6) [C(R6)2]p-SO3H. In embodiments, fin [CZ2]f is zero. Examples include 2-sulfoethyl methacrylate and 2-acrylamido-2-methylpropanesulfonic acid.
(iv) Alkenyl dicarboxylic acids and dicarboxylates, for example those having Formula 5 and their corresponding anhydrides according to Formula 6 or Formula 7:

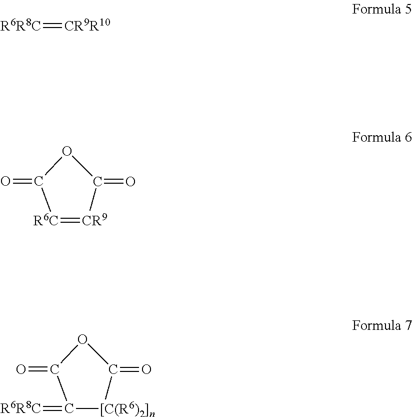

In these formulae, R8 is selected from R6 and —[C(R6)2]m-COOR11 and m is a whole number in the range of from about 0 to about 10; R9 is selected from R6 and —[C(R6)2]n-COOR11 and n is a whole number in the range of from about 1 to about 10, with the proviso that one, and only one, of R8 and R9 is R6; R10 is —COOR11; R11 is H or C1-20 alkyl or C1-20 alkenyl, optionally with one or more substituents selected from halo, hydroxyl or OR6. Examples of these monomers include fumaric acid, maleic acid and itaconic acid, including their anhydrides, esters and diesters, for example divinyl maleate and diallyl maleate.

(v) Dicarbonic acid, and its esters or diesters thereof, for example of Formula 8:

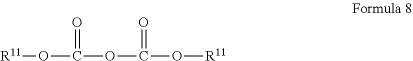

(vi) Epoxy-containing monomers, for example having Formula 9:

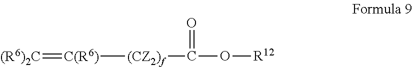

where R12 is a C1-20 alkyl group, such as a C1-10 alkyl group, substituted with at least one epoxy group, and optionally one or more halides. In embodiments, f in [CZ2]f is about 0. An example is glydicyl methacrylate.
(vii) Dicarboxylate or diacrylate monomers, for example of Formulae 10 to 12:

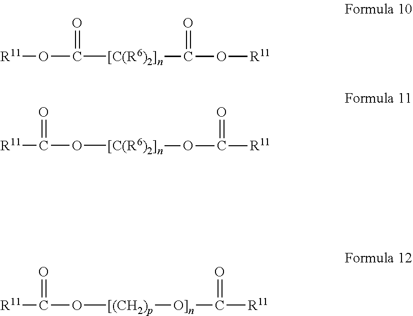

with examples including divinyl adipate, butandiol-1,4-dimethacrylate, hexanedioldiacrylate, and triethyleneglycoldimethacrylate.
(viii) Acrylamide-based monomers of formula 13:

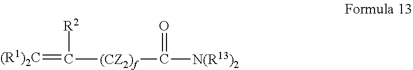

where each R13 is independently selected from H and C1-20 alkyl optionally substituted with one or more groups selected from hydroxyl, oxygen (in the form of a C═O group), amino, C1-6 alkoxy, C1-6 alkyl-amino and C1-6 dialkyl amino.

Examples include acrylamide, alkyl-acrylamides and aminoalkyl-acrylamides. In embodiments, fin [CZ2]f is about 0. In embodiments, none of R1 and R2 are halogen, and in further embodiments R1 and R2 are each independently selected from H and optionally substituted C1-10 alkyl. In further embodiments, each R1 and R2 are independently selected from hydrogen and unsubstituted C1-4 alkyl. In embodiments, each R13 is independently selected from R3. Acrylamide-based monomers typically comprise, in total, about 3 to about 15 carbon atoms, for example about 3 to about 8 carbon atoms, and in embodiments can be selected from acrylamide, methacrylamide, N-(3-dimethylaminopropyl)-methacrylamide, N-hydroxymethylacrylamide, N-hydroxymethylmethacrylamide, N-methylol(meth)acrylamide and N-[2-(dimethylamino)ethyl]methacrylate. These monomers also include the corresponding quaternary ammonium salts, as exemplified by N-[3-(Trimethyl-ammonium)propyl]methacrylamide chloride and N,N-[3-Chloro-2-hydroxypropyl)-3-dimethylammoniumpropyl](meth)acrylamide chloride.

(ix) Ketone group-containing acrylamide- or alkenylamide-based monomers, for example having Formula 14:

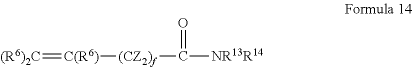

where R14 is selected from C1-20 alkyl comprising an oxygen substituent (in the form of a C═O group), and optionally comprising one or more additional substituents selected from hydroxyl, oxygen (in the form of a C═O group), amino, C1-6 alkoxy, C1-6 alkyl-amino and C1-6 dialkyl amino. In embodiments, fin [CZ2]f is about zero. Examples of these compounds include diacetoneacrylamide and diacetonemethacrylamide.
(x) Glycolate acrylamides or alkenylamides, for example those of Formula 15:

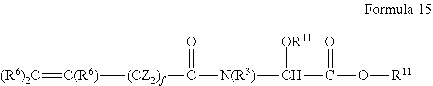

In embodiments, f in [CZ2]f is zero. Examples include acrylamidoglycolic acid and methylacrylamidoglycol methyl ether.

### (xi) Monomers of Formula 16:

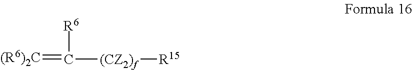

where R15 is a C5-8 aryl or C5-8 heteroaryl group comprising at least one C1-10 alkenyl group, optionally substituted with one or more groups selected from hydroxyl, halide, —N(R3)2, nitrile, C1-10 alkyl, C1-10 haloalkyl, C1-10 alkoxy and C1-10 haloalkoxy. The C5-8 aryl or heteroaryl group can comprise one or more further substituents, each selected from hydroxyl, halide, —N(R3)2, nitrile, C1-10 alkyl, C1-10 haloalkyl, C1-10 alkoxy and C1-10 haloalkoxy. In embodiments, fin [CZ2]f is about zero. An example of such a monomer is divinyl benzene.

(xii) Carbamate-based monomers of Formula 17:

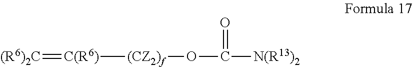

In embodiments, f in [CZ2]f is greater than about zero, for example about 1 or about 2. Examples include N-methylolallyl carbamate.

(xiii) Acrylonitrile-based polymers of Formula 18:

(R⁶)₂C═C(R⁶)—(CZ₂)_{f}—C≡N Formula 18

In embodiments, f is about zero. An example is acrylonitrile.
(xiv) C1-20 alkenyl cyanurate monomers, such as triallylcyanurate; and
(xv) C1-20 alkenyl sulfonic acids, for example C1-10 alkenyl sulfonic acids, such as vinyl sulfonic acid.

[Relative Quantities of Monomers]

The total amount of co-monomers compared to the monomer of Formula 1 (or the monomer of Formula 1 that is present in the highest weight content) can be in the range of from about 0 to about 50% by weight, for example in the range of from about 0 to about 30 wt %, from about 0 to about 20% by weight, or from about 0.1 to about 10% by weight. These values are based on the total amount of monomer.

As an example, if there is a monomer (A) of Formula 1, with a content of about 80 wt %, a monomer (B) of Formula 1 with a content of about 15 wt %, and a monomer (C) not of Formula 1 at about 5 wt %, then the amount of co-monomer would be considered to be the sum of monomers (B) and (C), i.e. about 20 wt %, since monomer (A) is the monomer of Formula 1 with the highest weight content.

Highly hydrophilic monomers, such as acrylamides and sulfonate based monomers, e.g. as listed in (iii), (ix), (x) and (xv) above, are typically avoided, or at least if present, they cumulatively represent less than about 5 wt % of the total monomer content.

[Example Co-monomer Combinations]

Examples of co-monomer combinations that can be used to make a polymer dispersion according to the present disclosure include ethylene/vinylacetate, ethylene/vinylacetate/vinylversatate, ethylene/vinylacetate/(meth)acrylate, ethylene/vinylacetate/vinylchloride, vinylacetate/vinylversatate, vinylacetate/vinylversatate/(meth)acrylate, vinylversatate/(meth)acrylate, acrylate/methacrylate, styrene/acrylate, styrene/butadiene and styrene/butadiene-acrylonitrile.

It is preferred that the monomer, or at least one monomer, is an optionally substituted vinyl carboxylate according to Formula 1, where X is

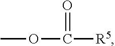

f is zero, R1 and R2 are both hydrogen, and R5 is H or unsubstituted C1-4 alkyl. In further embodiments, a mono-olefin is a co-monomer.

Thus, in embodiments, the monomer systems used are selected from the following: vinyl acetate, ethylene/vinylacetate, ethylene/vinylacetate/vinylversatate, ethylene/vinylacetate/vinylchloride, and vinylacetate/vinylversatate. Such monomer/co-monomer selections are often used for interior coatings applications, e.g. indoor decorative paints.

In certain embodiments, vinyl acetate is used as the sole monomer, or ethylene and vinyl acetate are used as comonomers.

Where a copolymer or mixture of polymers are used, the polymer dispersion can in embodiments contain from about 0 to about 70 mol % of vinyl carboxylate monomer units (e.g. vinyl acetate), based on the respective total monomer component of the individual polymers. In embodiments, the vinyl carboxylate content is about 65 mol % or less. In a further embodiment, the content is about 60 mol % or less, for example about 55 mol % or less. The content of vinyl carboxylate is, in embodiments, about 5 mol % or more, for example about 10 mol % or more, and in further embodiments about 20 mol % or more. Example ranges of vinyl carboxylate monomer in the polymer include from about 5 to about 70 mol %, from about 5 to about 65 mol %, from about 5 to about 55 mol %, from about 10 to about 70 mol %, from about 10 to about 65 mol %, from about 10 to about 55 mol %, from about 20 to about 70 mol %, from about 20 to about 65 mol %, and from about 20 to about 55 mol %.

In embodiments, an acrylate-based monomer can be a co-monomer, for example about 2 to about 80% by weight of total monomer. These can be of Formula 1, where X is

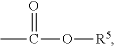

f is about zero, R1 is H, R2 is H or methyl, and R5 is H or unsubstituted C1-4 alkyl. In embodiments, from about 5 to about 60% by weight of acrylate-based monomer is included, or in another aspect from about 10 to about 50% by weight, for example from about 15 to about 35% by weight.

In embodiments, where there are carboxylate group-containing monomers, the component of carboxylic acid groups does not exceed about 10% by weight of the total carboxylate groups. In further embodiments, this FIGURE does not exceed about 5% by weight, and in further embodiments, the FIGURE does not exceed about 3% by weight.

[Organosilane-Functionalised Colloidal Silica]

In making the aqueous polymeric dispersion that forms part of the coating composition of the present disclosure, an organosilane-functionalised colloidal silica is added to the aqueous phase. In the discussion below, the terms “colloidal silica” and “silica sol” are synonymous.

The modified colloidal silica is an organosilane-functionalised colloidal silica, which can be made by conventional processes, as described for example in WO2004/035473 or WO2004/035474. This organosilane-functionalised colloidal silica comprises colloidal silica particles modified with an organosilane moiety. The organosilane moiety is typically sufficiently hydrophilic such that the modified colloidal silica mixes with and is stable within the aqueous phase of the composition.

Typically, the organosilane-functionalised colloidal silica is formed from a reaction between one or more organosilane reactants, which can be expressed generally by the formula A4-ySi-[Rm]y, and one or more silanol groups on the silica surface, i.e. [SiO2]—OH groups. The result is a silica surface comprising one or more organosilane moieties attached to the surface.

In the organosilane reactant, each “A” is typically independently selected from C1-6 alkoxy, C1-6 haloalkoxy, hydroxy and halide. Other options are the use of siloxanes, e.g. of formula [Rm]bA3-bSi{—O-SiA2-c[Rm]c}a-O-SiA3-b[Rm]b, where a is about 0 or an integer of about 1 or more, typically from about 0 to about 5; b is from about 1 to about 3; and c is from about 1 to about 2.

Alkoxy groups and halides are often preferred as the “A” species. Of the halides, chloride is a suitable choice. Of the alkoxy groups, C1-4 alkoxy groups, such as methoxy, ethoxy, propoxy or isopropoxy, are suitable choices. In embodiments, the organosilane reactant can undergo a prehydrolysis step, in which one or more “A” groups are converted to —OH, as described for example by Greenwood and Gevert, Pigment and Resin Technology, 2011, 40(5), pp 275-284.

The organosilane reactant can react with a surface silanol group to form from one to three Si—O—Si links between the silica surface and the organosilane silicon atom, i.e. {[SiO2]—O-}4-y-z-Si[A]z[Rm]y where z is typically from about 0 to about 2, y is typically from about 1 to about 3, and about 4-y-z is from about 1 to about 3, and usually in the range of from about 1 to about 2. A corresponding number of “A” groups are removed from the organosilane as a result of reaction with the silica surface. Remaining “A” groups can be converted to other groups as a result of reaction (e.g. hydrolysis) under the conditions experienced in the silanisation reaction. For example, if “A” is an alkoxy unit or a halide, it can convert to a hydroxyl group.

It is also possible for at least a portion of the organosilane to be in a dimeric form or even oligomeric form before binding to the colloidal silica, i.e. where the two or more organosilane moieties are bound to each other through Si—O—Si bonds. Such pre-condensed moieties can form if the above-mentioned pre-hydrolysis step is carried out before contacting the organosilane compound with the colloidal silica.

The chemically bound organosilane groups can be represented by the formula [{SiO2}—O-]4-y-z-Si[D]z[Rm]y. The group {SiO2}—O— represents an oxygen atom on the silica surface. The organosilane silicon atom has at least one, and optionally up to three such bonds to the silica surface, where about 4-y-z is from about 1 to about 3, and usually in the range of from about 1 to about 2, i.e. about 4-y-z is at least about 1, and no more than about 3. Group “D” is optionally present, and z is in the range of from about 0 to about 2. The organosilane silicon atom has from about 1 to about 3 [Rm] groups, i.e. y is from about 1 to about 3, typically from about 1 to about 2. Where there is more than about 1 Rm group, they can be the same or different.

When z is not zero, the organosilane silicon contains unreacted “A” groups, and/or contains hydroxyl groups where the “A” group has been removed, for example through a hydrolysis reaction. Alternatively or additionally, an Si—O—Si link can be formed with the silicon atom of a neighbouring organosilane group. Thus, in the formula {[SiO2]—O-}4-y-z-Si[D]z[Rm]y, group “D” can (on each occurrence) be selected from the groups defined under “A” above, and also from hydroxy groups and —O—[SiRm]′ groups where the [SiRm]′ group is a neighbouring organosilane group.

Rm is an organic moiety, comprising from about 1 to about 16 carbon atoms, for example from about 1 to about 12 carbon atoms, or from about 1 to about 8 carbon atoms. It is bound to the organosilane silicon by a direct C—Si bond.

Where there is more than one Rm group (i.e. if y is greater than about 1), then each Rm can be the same or different.

Rm is an organic, preferably hydrophilic moiety, whose nature is such that the modified colloidal silica is miscible with the aqueous phase, in preference to the organic phase. In embodiments, Rm comprises at least one group selected from hydroxyl, thiol, carboxyl, ester, epoxy, acyloxy, ketone, aldehyde, (meth)acryloxy, amino, amido, ureido, isocyanate or isocyanurate. In further embodiments, hydrophilic moieties comprise at least one heteroatom selected from O and N, and comprise no more than three consecutive alkylene (—CH2-) groups linked together.

Rm can comprise alkyl, alkenyl, epoxy alkyl, aryl, heteroaryl, C1-6 alkylaryl and C1-6 alkylheteroaryl groups, optionally substituted with one or more groups selected from ERn, subject to Rm overall being sufficiently hydrophilic as described above.

In ERn, E is either not present, or is a linking group selected from —O—, —S—, —OC(O)—, —C(O)—, —C(O)O—, —C(O)OC(O)—, —N(Rp)-, —N(Rp)C(O)—, —N(Rp)C(O)N(Rp)- and —C(O)N(Rp)- where Rp is H or C1-6 alkyl.

Rn is linked to E, or directly to Rm if E is not present, and is selected from halogen (typically F, Cl or Br), alkyl, alkenyl, aryl, heteroaryl, C1-3 alkylaryl and C1-3 alkylheteroaryl. Rn can optionally be substituted with one or more groups selected from hydroxyl, halogen (typically F, Cl or Br), epoxy, —ORp or —N(Rp)2 where each Rp is as defined above. If E is present, Rn can also be hydrogen.

In the above definitions, alkyl and alkenyl groups can be aliphatic, cyclic or can comprise both aliphatic and cyclic portions. Aliphatic groups or portions can be linear or branched. Where any group or substituent comprises halogen, the halogen is preferably selected from F, Cl and Br, although in embodiments the organosilane moiety is halide-free.

Some groups can undergo hydrolysis reactions under conditions experienced in the colloidal silica medium. Thus, groups containing moieties such as halide, acyloxy, (meth)acryloxy and epoxy groups can hydrolyse to form corresponding carboxyl, hydroxyl or glycol moieties.

In embodiments, one or more Rm groups are C1-8 alkyl, C1-8 haloalkyl, Cl-8 alkenyl or C1-8 haloalkenyl, typically C1-8 alkyl or C1-8 alkenyl, with an optional halide (e.g. chloride) substituent. Examples include methyl, ethyl, chloropropyl, isobutyl, cyclohexyl, octyl and phenyl. These C1-8 groups can, in embodiments, be C1-6 groups or, in further embodiments, C1-4 groups. Longer carbon chains tend to be less soluble in an aqueous system, which makes synthesis of the organosilane-modified colloidal silica more complex.

In embodiments, Rm is a group comprising from about 1 to about 8 carbon atoms, e.g. a C1-8 alkyl group, and which additionally comprises an ERn substituent where E is oxygen and Rn is selected from optionally substituted C1-8-epoxyalkyl and C1-8 hydroxyalkyl. Alternatively, Rn can be optionally substituted alkylisocyanurate. Examples of such ERn substituents include 3-glycidoxypropyl and 2,3-dihydroxypropoxypropyl.

In embodiments, Rm is a group comprising from about 1 to about 8 carbon atoms, e.g. a C1-8 alkyl group, and which additionally comprises an ERn substituent where E is not present, and Rn is epoxyalkyl, for example an epoxycycloalkyl. An example of such an Rm group is beta-(3,4-epoxycyclohexyl)ethyl. The epoxy group can alternatively be two neighbouring hydroxyl groups, e.g. Rn can be a dihydroxyalkyl such as a dihydroxycycloalkyl, and Rm being (3,4-dihydroxycyclohexyl)ethyl.

There can be more than one different organosilane in the modified colloidal silica, for example where the organosilane-modified silica is produced by reacting a mixture of two or more organosilanes with colloidal silica, or by mixing two or more separately prepared organosilane-modified colloidal silicas.

In embodiments, the colloidal silica can be modified by more than one organosilane moiety. The additional organosilane moieties do not necessarily themselves have to be hydrophilic in nature. For example, they can be hydrophobic silanes, such as C1-20 alkyl or alkenyl silane. However, the resulting modified colloidal silica should still be miscible with the aqueous phase.

Examples of organosilane reactants that can be used to make such functionalised colloidal silica include octyl triethoxysilane; methyl triethoxysilane; methyl trimethoxysilane; tris-[3-(trimethoxysilyl)propyl]isocyanurate; 3-mercaptopropyl trimethoxysilane; beta-(3, 4-epoxycyclohexyl)-ethyl trimethoxysilane; silanes containing an epoxy group (epoxy silane), glycidoxy and/or a glycidoxypropyl group such as 3-(glycidoxypropyl) trimethoxy silane (which can also be known as trimethoxy[3-(oxiranylmethoxy)propyl] silane), 3-glycidoxypropyl methyldiethoxysilane, (3-glycidoxypropyl) triethoxy silane, (3-glycidoxypropyl) hexyltrimethoxy silane, beta-(3, 4-epoxycyclohexyl)-ethyltriethoxysilane; 3-methacryloxypropyl trimethoxysilane, 3-methacryloxypropyl triisopropoxysilane, 3-methacryloxypropyl triethoxysilane, octyltrimethoxy silane, ethyltrimethoxy silane, propyltriethoxy silane, phenyltrimethoxy silane, 3-mercaptopropyltriethoxy silane, cyclohexyltrimethoxy silane, cyclohexyltriethoxy silane, dimethyldimethoxy silane, 3-chloropropyltriethoxy silane, 3-methacryloxypropyltrimethoxy silane, i-butyltriethoxy silane, trimethylethoxy silane, phenyldimethylethoxy silane, hexamethyldisiloxane, trimethylsilyl chloride, ureidomethyltriethoxy silane, ureidoethyltriethoxy silane, ureidopropyltriethoxy silane, hexamethyldisilizane, and mixtures thereof. U.S. Pat. No. 4,927,749 discloses further suitable silanes which may be used to modify the colloidal silica.

In embodiments, the organosilane or at least one organosilane comprises epoxy groups, for example as found in epoxyalkyl silanes or epoxyalkyloxyalkyl silanes. In embodiments, the organosilane can comprise a hydroxyl-substituent group, for example selected from hydroxyalkyl and hydroxyalkyloxyalkyl groups comprising one or more hydroxyl groups, e.g. about 1 or about 2 hydroxyl groups. Examples include organosilanes containing a glycidoxy, glycidoxypropyl, dihydropropoxy or dihydropropoxypropyl group. These can be derived from organosilane reactants such as (3-glycidoxypropyl)trimethoxysilane, (3-glycidoxypropyl)triethoxysilane and (3-glycidoxypropyl)methyldiethoxysilane. In the compositions of the present disclosure, epoxy groups can hydrolyse to form corresponding vicinal diol groups. Therefore, the present disclosure also encompasses the diol equivalents of the above epoxy group-containing compounds.

The silane compounds can form stable covalent siloxane bonds (Si—O—Si) with the silanol groups. In addition, they can be linked to the silanol groups, e.g. by hydrogen bonds, on the surface of the colloidal silica particles. It is possible that not all silica particles become modified by organosilane. The proportion of colloidal silica particles that become functionalised with organosilane will depend on a variety of factors, for example the size of the silica particles and the available surface area, the relative amounts of organosilane reactant to colloidal silica used to functionalise the colloidal silica, the type of organosilane reactants used and the reaction conditions.

The degree of modification (DM) of silica surface by organosilane can be expressed according to the following calculation (Equation 1), in terms of the number of silane molecules per square nanometre of silica surface:

$$D M = \frac{A \times {N}_{organosilane}}{( {S}_{silica} \times {M}_{silica} \times {10}^{18} )} \qquad Equation 1$$

wherein:
DM is the degree of surface modification in units of nm-2;
A is Avogadro's constant;
Norganosilane is the number of moles of organosilane reactant used;
Ssilica is the surface area of the silica in the colloidal silica, in m2 g-1; and
Msilica is the mass of silica in the colloidal silica, in g.

DM can be at least about 0.3 molecules of silane per nm2, for example in the range of from about 0.3 to about 4 molecules per nm2 Preferred embodiments have DM in the range of from about 0.5 to about 3, for example from about 1 to about 2.

In the above equation, the surface area of the silica is conveniently measured by Sears titration.

The colloidal silica used in the composition of the present disclosure is a stable colloid. By “stable” is meant that the organosilane-functionalised colloidal silica particles dispersed in the (usually aqueous) medium does not substantially gel or precipitate within a period of at least about 2 months, and preferably at least about 4 months, more preferably at least about 5 months at normal storage at room temperature (about 20° C.).

Preferably, the relative increase in viscosity of the silane-functionalised colloidal silica dispersion between its preparation and up to two months after preparation is lower than about 100%, more preferably lower than about 50%, and most preferably lower than about 20%.

Preferably, the relative increase in viscosity of the silane-functionalised colloidal silica between its preparation and up to four months after preparation is lower than about 200%, more preferably lower than about 100%, and most preferably lower than about 40%.

These values also apply to the coating composition, before it is applied to a surface and allowed to dry. The use of organofunctionalised colloidal silica shows benefits compared, for example, to “bare” colloidal silica, in imparting longer term storage stability by avoiding, or at least reducing, viscosity increase over time.

[Colloidal Silica Modified with Additional Element]

The silica particles within the modified colloidal silica can optionally also be modified with one or more additional elements on the surface. The one or more elements are formally able to adopt the +3 or +4 oxidation state, for example being able to form solid oxides at room temperature having stoichiometry M203 or M02. In embodiments, these are other elements in Groups 13 and 14 of the periodic table selected from the second to fifth periods (i.e. Ge, Sn, B, Al, Ga, In), and also transition elements in the fourth and fifth periods of the transition metals, such as Ti, Cr, Mn, Fe or Co. Zr and Ce can also be used as the surface-modifying element. In embodiments, the additional element is selected from B, Al, Cr, Ga, In, Ti, Ge, Zr, Sn and Zr. In particular embodiments, the element is selected from aluminium, boron, titanium and zirconium. In other embodiments, it is selected from aluminium and boron, and in further embodiments it is aluminium.

Various methods can be used to prepare colloidal silica with one or more additional elements on the surface of the colloidal silica particles. Boron-modified silica sols are described in U.S. Pat. No. 2,630,410, for example, and a procedure for preparing an aluminate-modified silica sol can be found in “The Chemistry of Silica”, by Iler, K. Ralph, pages 407-409, John Wiley & Sons (1979). Other references include U.S. Pat. Nos. 3,620,978, 3,719,607, 3,745,126, 3,864,142, 3,956,171, 5,368,833 and WO2005/097678.

The amount of one or more additional elements (expressed in terms of their oxide) based on the total amount of insoluble colloidal silica (expressed as SiO2) and additional elements (expressed as oxide) is typically in the range of from about 0.05 to about 3 wt %, for example in the range of from about 0.1 to about 2 wt %.

Alumina-modified silica particles suitably have an Al2O3 content of from about 0.05 to about 3 wt %, for example from about 0.1 to about 2 wt %, or from about 0.1 to about 0.8 wt %.

These amounts are typically over and above the amount of impurity oxides in the colloidal silica itself, which are typically no more than about 400 ppm in total (expressed as oxides).

In embodiments, the extent of modification with the modifying element is such that the colloidal silica comprises up to about 33.0 μmol of the one or more modifying elements per m2 of the colloidal silica particles. For example, the amount can be in the range of from about 18.4 to about 33 μmol m-2, such as in the range of from about 20 to about 31 μmol m-2, for example in the range about 21 to about 29 μmol m-2. The amount of one or more modifying elements is calculated on an elemental basis (i.e. the molar quantity of individual atoms of the one or more modifying elements). In other embodiments, the organosilane-modified colloidal silica contains little or no modifying element, for example no more than about 1 μmol m-2, or no more than about 0.1 μmol m-2.

Where the colloidal silica particles are surface modified both with an additional element, and with an organosilane, they are typically prepared by adding organosilane to the additional element-modified colloidal silica.

[Colloidal Silica]

In embodiments, the colloidal silica used in preparing organosilane-functionalised colloidal silica contains only traces of other oxide impurities, which will typically be present at less than about 1000 ppm (in the total sol) by weight for each oxide impurity. Typically, the total amount of non-silica oxide impurities present in the sol is less than about 5000 ppm by weight, preferably less than about 1000 ppm.

The colloidal silica particles suitably have an average particle diameter (on a volume basis) ranging from about 2 to about 150 nm, for example from about 3 to about 60 nm, such as from about 4 to about 25 nm. In further embodiments, the average particle diameter is in the range of from about 5 to about 20 nm. Suitably, the colloidal silica particles have a specific surface area from about 20 to about 1500 m2 g-1, preferably from about 50 to about 900 m2 g-1, and more preferably from about 70 to about 600 m2 g-1, for example from about 100 to about 500 m2 g-1 or from about 150 to about 500 m2 g-1.

The surface areas are often expressed as the surface areas of the “bare” or “unfunctionalised” colloidal silicas that are used for the synthesis. This is because functionalisation of a silica surface can complicate the surface area measurements. Surface areas can be measured using Sears titration (G. W. Sears; Anal. Chem., 1956, 28(12) pp1981-1983). The particle diameter can be calculated from the titrated surface area using a method described in “The Chemistry of Silica”, by Iler, K. Ralph, page 465, John Wiley & Sons (1979). Based on the assumption that the silica particles have a density of about 2.2 g cm-3, and that all particles are of the same size, have a smooth surface area and are spherical, then the particle diameter can be calculated from Equation 2:

$$Particle diameter ( nm ) = \frac{2720}{Surface Area ( {m}^{2} {g}^{- 1} )} \qquad Equation 2$$

The colloidal silica particles are typically dispersed in water in presence of stabilising cations, which are typically selected from K+, Na+, Li+, NH4+, organic cations, quaternary amines, tertiary amines, secondary amines, and primary amines, or mixtures thereof so as to form an aqueous silica sol. Dispersions can also comprise organic solvents, typically those that are water miscible e.g. lower alcohols, acetone or mixtures thereof, preferably in a volume ratio to water of about 20% or less. Preferably, no solvents are added to the colloidal silica or functionalsed colloidal silica. Organic solvents in the colloidal silica can arise during synthesis of the organosilane-functionalised colloidal silica, due to reaction of organosilane reactant with the silica. For example, if the organosilane reactant is an alkoxide, then the corresponding alcohol will be produced. The amount of any organic solvent is preferably kept below about 20% by weight, preferably less than about 10% by weight.

The silica content of the organo-functionalised colloidal silica is preferably in the range of from about 5 to about 60% by weight, more preferably from about 10 to about 50%, and most preferably from about 15 to about 45%. This is expressed as weight % of unfunctionalised silica, and is calculated from the weight % of silica in the colloidal silica source before modification with organosilane.

The pH of the modified colloidal silica is suitably in the range of from about 1 to about 13, preferably from about 2 to about 12, such as from about 4 to about 12, or from about 6 to about 12, and most preferably from about 7.5 to about 11. Where the silica is modified with an additional element, such as aluminium, the pH is suitably in the range of from about 3.5 to about 11.

The organofunctionalised colloidal silica suitably has an S-value from about 20 to about 100, preferably from about 30 to about 90, and more preferably from about 40 to about 90 and most preferably in the range of from about 60 to about 90.

The S-value indicates the extent of aggregation of colloidal silica particles, i.e. the degree of aggregate or microgel formation. The S-value can be measured and calculated according to the formulae given in Iler, R. K. & Dalton, R. L. in J. Phys. Chem., 60 (1956), 955-957.

The S-value is dependent on the silica content, the viscosity, and the density of the colloidal silica. A high S-value indicates a low microgel content. The S-value represents the amount of SiO2 in percent by weight present in the dispersed phase of a silica sol. The degree of microgel can be controlled during the production process as further described in e.g. U.S. Pat. No. 5,368,833.

As with surface area, the S-value of organosilane-functionalised colloidal silica is typically expressed as the S-value of the colloidal silica before silane modification.

In embodiments, the weight ratio of organosilane to silica in the organosilane-functionalised silica sol is from about 0.003 to about 1.5, preferably from about 0.1 to about 1.0, and most preferably from about 0.15 to about 0.5.

In this context, the weight of organosilane in the dispersion is calculated as the total amount of possible free organosilane compounds and organosilane derivatives or groups bound or linked to the silica particles, i.e. based on the total amount of organosilane reactant(s) initially added to the colloidal silica to produce the organosilane modified silica, and not necessarily based on a direct measure of how much organosilane is actually chemically bound to the silica.

When preparing the aqueous polymeric dispersion, the organosilane-functionalised colloidal silica is typically present in an amount of from about 0.01 to about 15 wt %, for example in the range of from about 0.1 to about 10 wt %. In particular embodiments, the modified colloidal silica is present in the final coating composition at a concentration in the range of from about 0.01 to about 5 wt %. for example from about 0.05 to about 3 wt %, from about 0.1 to about 2 wt % or from about 0.2 to about 1.0 wt %. These amounts are based on insoluble silica, expressed as SiO2.

[Initiators]

Polymerisation is carried out in the presence of an initiator. The initiator is water-soluble, or at least partially water-soluble. The initiator can be present in the aqueous phase before the aqueous and organic phases are mixed. Alternatively, it can be added either at the same time as or after mixing the organic and aqueous phases. In embodiments, at least some (typically at least about 90 mol % or at least about 95 mol %) of the initiator remains in the aqueous phase when the polymerisation reaction commences. Initiators are typically radical-generating initiators, and are well known in the art. Typical examples include at least partially water-soluble inorganic peroxides, organic peroxides, peroxydicarbonates and azo compounds.

Examples of inorganic peroxides include hydrogen peroxide, salts containing SO52- or S2O82- ions such as ammonium persulfate, sodium persulfate and potassium persulfate, and peroxydiphosphates such as ammonium or alkali metal peroxydiphosphate (e.g. potassium peroxydiphosphate).

Examples of azo compounds include those of Formula R16-N═N—R17, where R16 and R17 can be the same or different, and each can be selected from H, C1-4 alkyl and C1-4 alkenyl. Any of the C1-4 alkyl, C1-4 alkenyl groups can be optionally substituted with one or more substituents selected from halogen, hydroxyl, C1-4 alkoxy, carboxyl groups of formula COOR18, nitrile, amines of formula N(R18)2 and amidines of formula —C(NR3)N(R3)2. R18 is H or C1-4 alkyl. Examples include 2,2′-azobis(2-methylpropionamidine), optionally in the form of a dihydrochloride or diacetatic acid salts, and also nitrile-containing azo compounds such as 4,4′-azobis(4-cyanovaleric acid) and 2,2′-azobis(2-methylpropionitrile).

Organic peroxides include those of formulae 18 to 20:

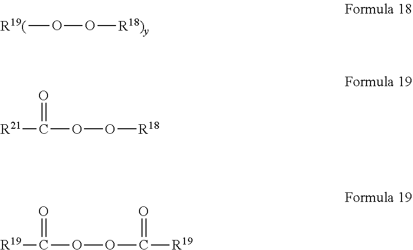

where R19 is selected from C1-10 alkyl, C1-10 alkenyl, and —[CZ2]f-R20. Any of the C1-10 alkyl or C1-10 alkenyl groups can optionally be substituted with one or more substituents selected from halogen, hydroxyl, carboxyl groups of formula COOR18, nitrile, amines of formula N(R18)2 and C1-4 alkoxy. In embodiments, f is from about 0 to about 2.

R20 on each occurrence is independently selected from C5-6 aryl and C5-6 heteroaryl groups. The aryl or heteroaryl groups can optionally be substituted with one or more groups selected from hydroxyl, halide, —N(R18)2, nitrile, C1-3 alkyl, C1-3 haloalkyl, C1-3 alkoxy and C1-3 haloalkoxy. The heteroaryl group comprises one or more heteroatoms in the ring, each independently selected from O, S and N.

R21 is selected from H and R19.

y is about 1 or about 2.

Examples of organohydroperoxides include those of Formula 18 above, where at least one R18 (or all R18) is hydrogen. Specific examples include cumene hydroperoxide and t-butyl hydroperoxide.

Examples of diorganoperoxides include those of Formula 18 above, where at least one R20 (or all R20) are not hydrogen, for example di tert-butyl peroxide, bis(tert-butylperoxy)cyclohexane.

Examples of peracids include those of Formulae 19 above, where R20 is hydrogen, for example peroxo-carboxylic acids such as peracetic acid.

Examples of diorganoperoxides of Formula 20 include those where bother R19 are —[CZ2]f-R20, with a specific example being benzoyl peroxide.

Peroxydicarbonates include compounds with the anion [O₂C—O—O—CO₂]²⁻, and can be provided as alkali metal salts, for example lithium peroxydicarbonate, sodium peroxydicarbonate and potassium peroxydicarbonate.

Other initiators that can be used include reduction agents such as sodium, potassium or ammonium salts of sulfite and bisulfite; sodium, potassium or zinc formaldehyde sulfoxylate, and ascorbic acid.

Further types of initiators include oxidizing agents which, by thermal decomposition, can form free radicals, and also catalytic initiator systems such as the system H2O2/Fe2+/H+.

The content of initiators based on the amount of monomer can be in the range of about 0.01 to about 5% by weight, for example in the range of from about 0.1 to about 3% by weight.

[Polymer Dispersion Formation]

In embodiments, an organic emulsion is formed typically by mixing the organic monomer phase, and an aqueous phase. In embodiments, the radical initiator is at least partially soluble in the aqueous phase. It can be included in the aqueous phase before mixing with the organic phase. In other embodiments, it can be added to the aqueous phase at the same time as the organic phase. The continuous phase of the emulsion is the aqueous phase, with the organic phase being the dispersed phase, i.e. an “oil-in-water” type emulsion.

The polymerisation can take place in a batch-process, in a continuous process, or in a semi-continuous process. In one embodiment, the initiator and monomers can be added over a period of time, for example to help control the rate of reaction and the temperature increase in the system as a result of the exothermic reaction.

The result is the formation of an aqueous dispersion of polymeric particles.

[Stabilisers]

Various additives can be added to help stabilise the aqueous polymeric emulsion or dispersion. In the present disclosure, at least one of these stabilisers is a protective colloid stabiliser.

Examples include cold water-soluble biopolymers. In one embodiment, these can be selected from polysaccharides and polysaccharide ethers, such as cellulose ethers, starch ethers (amylose and/or amylopectin and/or their derivatives), guar ethers, dextrins and/or alginates, heteropolysaccharides which may have one or more anionic, nonionic or cationic groups, such as xanthan gum, welan gum and/or diutan gum. These may be chemically modified, for example containing carboxymethyl, carboxyethyl, hydroxyethyl, hydroxypropyl, methyl, ethyl, propyl, sulfate, phosphate and/or long-chain (e.g. C4-26) alkyl groups.

Further examples include peptides and proteins such as gelatine, casein and/or soy protein.

In embodiments, the biopolymer is selected from dextrins, starches, starch ethers, casein, soy protein, gelatine, hydroxyalkyl-cellulose and/or alkyl-hydroxyalkyl-cellulose, wherein the alkyl group may be the same or different and can be a C1-4 alkyl group, in particular a methyl, ethyl, n-propyl- and/or i-propyl group.

Other examples of protective colloids include synthetic polymers selected from polyvinyl alcohols, partially hydrolyzed polyvinyl acetates, polyacrylates, polyvinylpyrrolidones and polyvinylacetals.

Polyvinyl pyrrolidone and/or polyvinylacetals typically have a molecular weight of about 2000 to about 400,000.

Polyvinyl alcohol (PVOH) is typically synthesised by hydrolysis of polyvinyl acetate to form a fully or partly saponified (hydrolysed) polyvinyl alcohol. The degree of hydrolysis is typically in the range of from about 70 to about 100 mol %, for example in the range of from about 80 to about 98 mol %. The PVOH typically has a Hoppler viscosity in about 4% aqueous solution of about 1 to about 60 mPas, for example in the range of from about 3 to about 40 mPas (measured at 20° C. according to DIN 53015). In embodiments, the molecular weight of the PVOH is in the range of from about 5000 to about 200000, for example from about 20000 to about 100000.

In embodiments, the polyvinyl alcohol can be modified, for example by converting at least a portion of the —OH groups C1-4 alkoxy groups, optionally having an OH substituent, or polyether groups such as —O—[(CH2)aO—]bH, where a is about 2 or about 3, and b is from about 1 to about 10, for example from about 1 to about 5.

A skilled person knows examples of protective colloids that are suitable for use in the present disclosure, for example from U.S. Pat. Nos. 3,769,248, 6,538,057 and WO2011/098412.

One or more protective colloids can be used. In addition, they can be used in combination with other stabilisers or emulsifiers.

Suitable emulsifiers include anionic, cationic and nonionic emulsifiers. Examples include melamine-formaldehyde-sulfonates, naphthalene-formaldehyde-sulfonates, block copolymers of propylene oxide and ethylene oxide, styrene-maleic acid and/or vinyl ether maleic acid copolymers. Higher-molecular oligomers can be non-ionic, anionic, cationic and/or amphoteric surfactants such as alkyl sulfonates, alkylaryl sulfonates, alkyl sulfates, sulfates of hydroxylalkanoles, alkyl and alkylaryl disulfonates, sulfonated fatty acids, sulfates and phosphates of polyethoxylated alkanoles and alkyl phenols, as well as esters of sulfo-ambric acid quaternary alkyl ammonium salts, quarternary alkyl phosphonium salts, polyaddition products such as polyalkoxylates, for example, adducts of 5 to 50 mol of ethylene oxide and/or propylene oxide per mol on linear and/or branched C6-22 alkanols, alkyl phenols, higher fatty acids, higher fatty acid amines, primary and/or secondary higher alkyl amines, wherein the alkyl group in each case can be a linear and/or branched C6-22 alkyl group.

Useful synthetic stabilization systems include partially saponified, and optionally, modified, polyvinyl alcohols, wherein one or several polyvinyl alcohols can be employed together, if applicable, with minor quantities of suitable surfactants. Amounts of the stabilization systems based on monomer component employed can be in the range of from about 1 to about 30% by weight, or in other embodiments from about 3 to about 15% by weight.

In certain embodiments, the protective colloid is a polyvinyl alcohol, fully or partly saponified, and having a degree of hydrolysis in the range of from about 70 to about 100 mol %, or in another embodiment in the range of from about 80 to about 98 mol %. The Hoppler viscosity in 4% aqueous solution can be about 1 to about 60 mPas, or in other embodiments in the range of from about 3 to about 40 mPas (measured at about 20° C. according to DIN 53015).

In embodiments, the present disclosure relates to improving the properties of a polyvinyl acetate-based coating composition by incorporation of an organosilane-functionalised colloidal silica.

In embodiments, the coating composition comprises polyvinyl acetate polymer or a polyvinyl acetate copolymer, where vinyl acetate monomer is polymerised in the presence of one or more additional monomers, in particular olefin monomers such as C2-C4 olefins, especially ethylene. Mixtures of polyvinyl acetate with one or more polyvinyl acetate copolymers can also be used, as can mixtures of more than one polyvinyl acetate copolymer.

[Polymer Properties]

In embodiments, the polymer in the polymer dispersion has a glass transition temperature Tg in the range of from about −25 to about +45° C., for example from about −25 to about +35° C., from about −25 to about +25° C., or from about −20 to about +20° C. In further embodiments, it is in the range of from about −10 to about +15° C., for example from about 0 to about 10° C. The dispersion can, in embodiments, comprise two different polymers, with different glass transition temperatures (for example as described in U.S. Pat. No. 8,461,247). In embodiments, the Tg of one or more than one of the different polymers in a mixture of polymers is within the above range.

Where copolymers are present, the glass transition temperature of the copolymer can either be calculated empirically or determined experimentally. Empirical calculation can be accomplished by use of the Fox equation (T. G. Fox, Bull. Am. Phy. Soc. (Ser II) 1, 123 (1956), and Ullmann's Encyclopedia of Industrial Chemistry, VCH, Weinheim, Vol. 19, 4th Ed., Publishing House Chemistry, Weinheim, 1980, pp. 17-18) as follows:

$$\frac{1}{{T}_{g}} = \frac{{X}_{a}}{{T}_{gA}} + \frac{{X}_{b}}{{T}_{gB}} + … + \frac{{X}_{n}}{{T}_{gN}}$$

wherein Xa and Xb are the mass fractions of monomers A and B employed in the copolymer (in % by weight), and TgA and TgB, are the glass transition temperatures Tg in Kelvin of the respective homopolymers A and B. These can be found, for example, in Ullmann's Encyclopedia of Industrial Chemistry, VCH, Weinheim, Vol. A21 (1992), p. 169.

Experimental determination can be undertaken by known techniques, such as differential scanning calorimetry (DSC), wherein the midpoint temperature according to ASTM D3418-82 should be used.

The minimum film-forming temperature as determined by DIN 53787 of a about 50% aqueous composition is in embodiments about 40° C. or less, for example about 25° C. or less. In further embodiments, it is about 15° C. or less. This can be tailored by selecting polymers of appropriate Tg values, and also by using mixtures of polymers. Plasticisers can also be used, for example those described in U.S. Pat. No. 4,145,338.

The volatile organic content (VOC) of the coating composition is preferably less than about 5000 ppm, for example less than about 2000 ppm, such as less than about 1000 ppm, or less than about 500 ppm based on polymer content. Volatile in this context refers to organic compounds having a boiling point of less than about 250° C. at standard (atmospheric) pressure.

The use of organosilane-functionalised colloidal silica in the aqueous phase, and having it present during the polymerisation process, confers significant advantages not only on the synthesis, but also in the resulting product, in particular improved strain resistance of the dried or cured coating composition.

In addition, there is an advantage of adding functionalised colloidal silica to the aqueous phase when preparing the aqueous polymeric dispersion, as opposed to adding the functionalised colloidal silica to the already prepared dispersion as a formulation additive of the final coating composition. This is because post-addition would involve dilution of the polymer component in the final dispersion. Including it instead as part of the initial polymerisation mixture means that the aqueous component of the functionalised colloidal silica can be accommodated by adding less additional water to the aqueous phase.

The median particle size (volume-based) of the so-formed polymer particles is typically less than about 1.5 μm, for example less than about 1.0 μm. Typically, the median particle size is greater than about 0.05 μm, for example greater than about 0.2 μm.

[Coating Composition]

The coating composition comprises the aqueous polymeric dispersion described above.

The amount of polymer in the aqueous dispersion and or the coating composition is typically in the range of from about 20 to about 80 wt %, for example in the range of from about 30 to 7 about 0 wt %. In embodiments, the amount is in the range of from about 40 to about 60 wt %, such as from about 45 to about 55 wt %.

Without being bound by theory, it is thought that functional groups on the colloidal silica, i.e. silanol groups on the silica surface directly, or functional groups (e.g. OH groups) on the organosilane moiety, can chemically interact (e.g. through covalent bonds, through hydrogen bonds or through ionic bonds) with the groups of the protective colloid on the surface of the polymer particles, thus providing additional sources of inter-polymer particle bonding during the drying and/or curing process. This bonding will be present to at least a certain extent in the as-prepared coating composition, but will be present to a much greater extent in the dried (or cured) composition. The extended cross-linking can improve the coating's resistance to contaminant absorption beneath the surface of the dried coating, and can also improve chemical resistance to contaminants that could otherwise partially dissolve any of coating's constituents.

Although such bonding can exist when unmodified colloidal silica particles are used, unmodified silica can result in a composition with poor long term stability, and hence low shelf-life. In organosilane-modified silicas, the number of surface silanol groups is reduced, which can help avoid silica agglomeration. It may also restrict the rate of reaction with protective colloid before use, thus helping to avoid too early curing or agglomeration of the dispersed polymer particles.

The pH of the coating composition is typically in the range of from about 2 to about 10, for example from about 3 to about 8 or from about 4 to about 7.

The viscosity of the coating composition at about 20° C. is in embodiments in the range of from about 0.01 to about 40 Pas, for example in the range of from about 0.05 to about 20 Pas. Viscosity can be routinely measured, for example using a Brookfield viscometer, or by standard method ASTM D5125.

[Other Components]

One or more additional components can be present in the coating composition, for example selected from those detailed further below.

One or more dispersant or wetting agents can be included, for example one or more polysiloxanes. Where used, they can be present in a total amount of from about 0.05 to about 2.0 wt %, for example from about 0.1 to about 1.0 wt % based on the total weight of the coating composition.

In embodiments, one or more coalescing agents or plasticizers can be included, for example selected from glycol or glycol ethers. Where used, they can be present in a total amount of from about 0.5 to about 5.0 wt %, for example from about 1.0 to about 3.0 wt % based on the total weight of the coating composition.

In embodiments, one or more defoamers can be added, for example selected from polysiloxanes. Where used, they can be present in a total amount of from about 0.05 to about 1.0 wt %, for example from about 0.1 to about 0.3 wt % based on the total weight of the coating composition.

In embodiments, one or more pigments can be added, for example opacifying pigments, such as titanium dioxide, zinc oxide or leaded zinc oxide, or coloured or tinting pigments, such as carbon black, iron oxides (including sienna and umber), cobalt pigments, ultramarine, cadmium pigments, chromium pigments, and organic pigments such as azo pigments and phthalocyanine pigments. Where used, they can be present in a total amount of from about 5 to about 40 wt %, for example from about 10 to about 25 wt % based on the total weight of the coating composition.

In embodiments, one or more fillers can be included in the composition, for example selected from crystalline and non-crystalline silicas, clays such as silicate and aluminium silicate clays (including mica and talc), and calcium carbonate. When used, they can be present in a total amount of from about 5 to about 40 wt %, for example from about 10 to about 25 wt % based on the total weight of the coating composition.

In embodiments, one or more thickeners can be included, for example selected from polyurethane-based thickeners and cellulose-based thickeners, for example ethyl cellulose, methyl cellulose, hydroxypropylmethyl cellulose, MEHEC (methyl ethyl hydroxyethyl cellulose), EHEC (ethyl hydroxylethyl cellulose) and HEC (hydroxyethyl cellulose). Examples of such products are marketed by Nouryon under the trade name Bermocoll®. Additional examples include urethane-based thickeners, for example the so-called HEUR, HASE or HEURASE thickeners. HEUR stands for hydrophobically modified ethoxylate and urethane thickeners, HASE for hydophobically modified alkali soluble emulsion, and HEURASE for hydrophobically modified ethyoxylate urethane alkali-swellable emulsion. Other thickeners include HM-PAPE thickeners (hydrophobically modified polyacetal polyether thickeners), described for example in WO 2003/037989, U.S. Pat. Nos. 5,574,127 and 6,162,877. Further examples of thickeners include starches and modified starches, chitosan and polysaccharide gums such as guar gums, Arabic gums, Welan gum and xanthan gums.

When used, thickeners can be present in a total amount of from about 0.1 to about 3.0 wt %, for example about 0.3 to about 1.5 wt %, based on the total weight of the coating composition.

In embodiments, one or more dispersants can be included, for example selected from anionic surfactants. When used, they can be present in a total amount of from about 0.1 to about 3.0 wt %, for example from about 0.3 to about 1.0 wt %, based on the total weight of the coating composition.

In embodiments, one or more rheology modifiers can be used, for example selected from non-ionic surfactants such as Surfynol 104 (2,4,7,9-tetramethyl-5-decyne-4,7-diol). Where used, they can be present in a total amount of from about 0.1 to about 3.0 wt %, for example 0.3 to about 1.0 wt %, based on the total weight of the coating composition.

In embodiments, one or more biocides can be added. Where present, they can be present in a total amount of from about 10 to about 500 ppm, for example about 20 to about 200 ppm, based on the total weight of the coating composition.

Other additives that can optionally be included in the coating composition include driers, secondary driers, drying accelerating complexing agents, hydration accelerators, hydration retarders, air-entraining admixtures, anti-settling agents, anti-sagging agents, de-airing agents, levelling agents, UV stabilizers, anti-static agents, anti-oxidants, anti-skinning agents, flame-retardant agents, lubricants, extenders, anti-freezing agents, waxes, thickeners, and thixotropic agents.

[Solvents]

In addition to water, whether separately added or part of the aqueous polymeric dispersion, the coating composition can comprise one or more additional solvents, for example organic solvents. However, the content of such additional solvents is preferably no more than about 30 wt %, more preferably no more than about 20 wt % and even more preferably no more than about 10 wt %, based on the total amount of water and additional solvent.

Examples of organic solvents that can be used include ethylene glycols, propylene glycols, ethylene glycol ethers such as phenyl- and C1-4 alkyl-ethylene glycol ethers, and propylene glycol ethers such as phenyl- and C1-4 alkyl-propylene glycol ethers. In embodiments, mixtures of glycol ethers and alcohols can be used. In further embodiments, one or more dibasic esters or ester alcohols can be used. Polar solvents and water-miscible solvents are preferred.

Specific examples of suitable commercially available organic solvents include Lusolvan™ FBH (di-isobutyl ester of a mixture of dicarboxylic acids), Lusolvan™ PP (di-isobutyl ester of a mixture of dicarboxylic acids), Loxanol™ EFC 300 (C12 and C14 fatty acid methyl esters), Butyl Carbitol™ (diethylene glycol monobutyl ether), Butyl Cellosolve (ethylene glycol monobutyl ether), Dowanol™ EPh (ethylene glycol phenyl ether), Dowanol™ PPh (propylene glycol phenyl ether), Dowanol™ TPnB (tripropylene glycol n-butyl ether), Dowanol™ DPnB (di(propylene glycol) butyl ether, mixture of isomers), DBE-9™ (a mixture of refined dimethyl gluterate and dimethyl succinate), Eastman DB™ solvent (diethylene glycol monobutyl ether), Eastman EB™ (ethylene glycol monobutyl ether), Texanol™ (2,2,4-trimethyl-1,3-pentanediol monoisobutyrate), Dapro™ FX 511 (2-ethyl hexanoic acid), Velate™ 262 (isodecyl benzoate), and Arcosolve™ DPNB (dipropylene glycol normal butyl ether).

Predominantly aqueous coating compositions are preferred, since they avoid high volatile organic compounds (VOC) content that are often associated with organic solvent-borne paints.

In one embodiment the liquid coating composition comprises organic solvent in an amount in the range of from about 0 to about 5.0 wt %, such as about 0 to about 3.0 wt %, or from about 0.1 to about 5.0 wt %, such as from about 0.2 to about 3.0 wt %, based on the total weight of the coating composition.

[Substrates]

Suitable substrates which may be coated with the coating composition include wood, wooden based substrates (e.g. MDF, chipboard), metal, stone, plastics and plastic films, natural and synthetic fibers, glass, ceramics, plaster, asphalt, concrete, leather, paper, foam, masonry, brick and/or board.

The coating composition can be applied to such substrates by any conventional method, including brushing, dipping, flow coating, barrel coating, spraying (e.g. conventional spraying, airless spraying, electrostatic spraying, hot spraying), electrostatic bell or disk coating, curtain coating, roller coating or pad coating.

The coating composition can be in the form of a paint, varnish or lacquer, and is in embodiments a paint, such as an interior decorative paint.

[General Comments]

In the discussion above, where concentrations of components of the coating composition are mentioned, they refer to the undried coating composition, i.e. before being applied to a substrate.

The coating composition after application will form a coating film after drying and (where applicable) curing.

### EXAMPLES

### Example 1

A solution was prepared by adding 23.0 g poly(vinyl alcohol), 23.7 g of an organosilane-functionalised colloidal silica, and 1.1 g sodium bicarbonate to 292 g deionised water in a reactor. This was heated to 60° C. under a nitrogen atmosphere. 38.0 g vinyl acetate (monomer) and 15.0 g of a 1.6 wt % aqueous solution of potassium persulfate were then added. After 15 minutes, the reaction temperature had increased to 67° C., and 342 g of vinyl acetate (monomer) and 56.0 g of the 1.6 wt % potassium persulfate solution were continuously added over a period of 3 hours. A further 4 g of the 1.6 wt % potassium persulfate solution was finally added, and the mixture was held at 67° C. for a further hour before being cooled to room temperature.

The organosilane-functionalised colloidal silica was a commercial Levasil® CC301 grade, functionalised with 3-glycidoxypropyl silane. The properties of the colloidal silica were: silica content 30 wt %, pH 7, surface area 360 m2 g-1 and average particle size of 7 nm (based on equation 2 above). The degree of modification (DM, based on the calculation of Equation 1 above) was 1.4 nm-2.

The amount of the silica (expressed as SiO2) in the coating composition is 0.9 wt %.

### Example 2

The procedure of Example 1 was followed, except that the organosilane-functionalised colloidal silica was Levasil® CC151 which is also modified with 3-glycidoxypropyl silane, and which has the following properties: silica content 15 wt %, pH 8.0, surface area 500 m2 g-1, average particle size 5 nm (based on equation 2 above). The DM was 2.0 nm-2.

The amount of de-ionized water and Levasil® CC151 were adapted to ensure that the poly(vinyl alcohol) and insoluble silica content in the final coating composition were the same as in Example 1.

### Example 3 (Comparative)

The procedure of Example 1 above was followed, except no organosilane-functionalised colloidal silica was added.

### Example 4 (Comparative)

The procedure of Example 1 above was followed, except that a non-functionalised (“bare”) colloidal silica was used, in this case Levasil® CT36M, with a silica content of 30 wt % (as SiO2), a pH of 10, a surface area of 360 m2 g-1, and a particle size of 7 nm (based on equation 2 above).

As with Example 2, the amount of de-ionized water and Levasil® CT36M were adapted to ensure that the poly(vinyl alcohol) and insoluble silica content in the final coating composition were the same as in Example 1.

Experiment 1

Films of each of Examples 1, 2 and 3, with a wet thickness of 60 μm, were cast on a glass plate and allowed to dry for 24 h under ambient conditions.

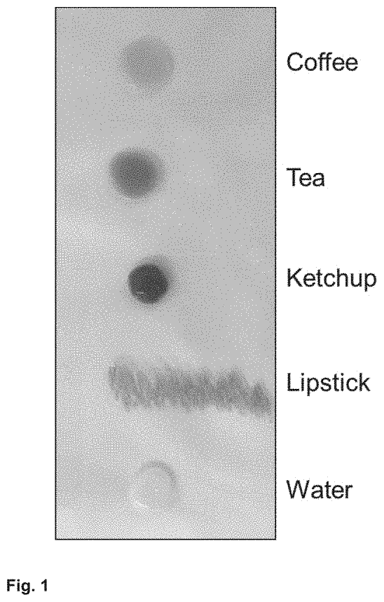

Coffee, tea, tomato ketchup, lipstick and water were applied as shown in FIG. 1, and left for a period of 90 minutes.

After 90 minutes, the glass plates were rinsed off with deionised water from a deionised water tank. The procedure involved allowing water to flow from the tap of a deionised water tank at a rate of 4 L min-1, through a 5 cm piece of tubing with an inner diameter of 0.9 cm. The glass plates were each held for 20 s at a 45° angle to the (vertical) water flow direction for 20 s, such that the water was allowed to completely soak the glass plate, and rinse the chemicals. The plates were then allowed to dry before their stain characteristics were assessed.

The plates were assessed visually, and a score of 1 to 10 was given to the extent of stain persistence on the glass plate, where 1 is no observable staining, 4 is weak staining, 7 is moderate staining, and 10 is significant staining Results are shown in Table 1.

TABLE 1
Staining Evaluation Results

| Staining Agent | Example 3 (comp.) | Example 1 | Example 2 |
|---|---|---|---|
| Coffee | 7 | 5 | 2 |
| Tea | 8 | 7 | 4 |
| Ketchup | 4 | 3 | 2 |
| Lipstick | 10 | 9 | 8 |
| Water | 7 | 6 | 5 |

For all different contaminants studied, coatings made from organosilane-functionalised colloidal silica-containing polymer showed improved stain resistance compared to samples containing no modified colloidal silica.

Experiment 2

Viscosity data for the undried coating compositions were collected after their preparation, and after 2 months storage at room temperature. Data were obtained on a Brookfield LV DV-I+ device using spindle LV64 at a rate of 12 rpm, and at a temperature of 20° C. Table 2 shows the results.

TABLE 2
Viscosity Data

| Example | Initial Viscosity (Pa s) | Viscosity after 2 months (Pa s) |
|---|---|---|
| 2 | 8.25 | 8.30 |
| 3 | 6.30 | 6.35 |
| 4 | 15.8 | 45.8 |

These results demonstrate that use of the organosilane-functionalised colloidal silica provides significant storage stability improvements compared to the use of unmodified colloidal silica, since the viscosity is almost unchanged over at least a two month period, whereas the sample made using non-functionalised colloidal silica shows a significant viscosity increase over the same period.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. A method for preparing a coating composition, in which an aqueous phase comprising an organosilane-functionalised colloidal silica is mixed with an organic phase comprising one or more monomers in the presence of an initiator and a protective colloid, wherein conditions are maintained such that polymerisation of the one or more monomers occurs to form an aqueous polymeric dispersion, in which;
(i) the aqueous polymeric dispersion comprises polymer particles with protective colloid on their surface;
(ii) the organosilane-functionalised colloidal silica comprises colloidal silica particles with at least one surface-bound organosilane moiety; and
(iii) the initiator is at least partially soluble in water.

2. A coating composition comprising an aqueous polymeric dispersion and organosilane-functionalised colloidal silica particles, in which;
(i) the aqueous polymeric dispersion comprises polymer particles with protective colloid on their surface;
(ii) the organosilane-functionalised colloidal silica comprises colloidal silica particles with at least one surface-bound organosilane moiety; and
(iii) at least a portion of the colloidal silica particles chemically interact with the protective colloid.

3. A coating composition prepared by the method of claim 1.

4. The method of claim 1 in which one or more of the following conditions apply:
i) at least one monomer is selected from alkenyl carboxylates;
ii) the protective colloid is a saponified or partially saponified polyvinyl alcohol with a degree of hydrolysis of from about 70 to about 100 mol %
iii) the organosilane moiety is a hydrophilic moiety comprising at least one group selected from hydroxyl, thiol, carboxyl, ester, epoxy, acyloxy, ketone, aldehyde, (meth)acryloxy and amino groups;
iv) the initiator is selected from inorganic peroxides, organic peroxides, peroxydicarbonates and azo compounds.

5. The method of claim 4, in which one or more of the following conditions apply:
i) there are two or more monomers, at least one monomer being an alkenyl carboxylate and at least one being another alkenyl carboxylate or an olefin;
ii) the organosilane moiety comprises an epoxy group or at least one hydroxyl group.

6. The method claim 1, further comprising the step of drying the coating composition and in which one or more of the following conditions apply;
i) the silica content of the coating composition before drying is of from about 0.01 to about 5 wt %;
ii) the amount of protective colloid, based on the total amount of protective colloid plus monomer, is of from about 1 to about 30 wt %;
iii) the amount of polymer in the aqueous polymer dispersion and/or in the undried coating composition is of from about 20 to about 80 wt %;
iv) the Tg of the polymer in the aqueous polymer dispersion is of from about −25 to about +45° C.;
v) the VOC content of the undried coating composition is less than about 5000 ppm;
vi) the volume-based median particle size of the polymer particles or droplets in the aqueous polymer dispersion is less than about 1.5 μm.

7. The method of claim 1, in which;
(i) the polymer is a vinyl acetate homopolymer, or a vinyl acetate-ethylene copolymer; and/or
(ii) the organosilane moiety is 3-glycidyloxypropyl silane.

8. The method of claim 1 in which the organosilane-functionalised colloidal silica particles comprise at least one surface-bound organosilane moiety.

9. The method of claim 8, in which the organosilane moiety is hydrophilic, comprising at least one group selected from hydroxyl, thiol, carboxyl, ester, epoxy, acyloxy, ketone, aldehyde, (meth)acryloxy and amino groups.

10. The method of claim 8, in which the coating comprises a polymeric binder.

11. The method of claim 10, in which the polymeric binder is made from at least one alkenyl carboxylate monomer, and optionally also comprises a protective colloid.

12. (canceled)

13. The coating composition of claim 2 in which one or more of the following conditions apply:
i) at least one monomer is selected from alkenyl carboxylates;
ii) the protective colloid is a saponified or partially saponified polyvinyl alcohol with a degree of hydrolysis of from about 70 to about 100 mol %
iii) the organosilane moiety is a hydrophilic moiety, comprising at least one group selected from hydroxyl, thiol, carboxyl, ester, epoxy, acyloxy, ketone, aldehyde, (meth)acryloxy and amino groups;
iv) the initiator is selected from inorganic peroxides, organic peroxides, peroxydicarbonates and azo compounds.

14. The coating composition of claim 2 in which one or more of the following conditions apply:
i) there are two or more monomers, at least one monomer being an alkenyl carboxylate and at least one being another alkenyl carboxylate or an olefin;
ii) the organosilane moiety comprises an epoxy group or at least one hydroxyl group.

15. The coating composition of claim 2 in which one or more of the following conditions apply;
i) the silica content of the coating composition before it is allowed to dry is of from about 0.01 to about 5 wt %;
ii) the amount of protective colloid, based on the total amount of protective colloid plus monomer, is of from about 1 to about 30 wt %;
iii) the amount of polymer in the aqueous polymer dispersion and/or in the undried coating composition is of from about 20 to about 80 wt %;
iv) the Tg of the polymer in the aqueous polymer dispersion is of from about −25 to about +45° C.;
v) the VOC content of the undried coating composition is less than about 5000 ppm;
vi) the volume-based median particle size of the polymer particles or droplets in the aqueous polymer dispersion is less than about 1.5 μm.

16. The coating composition of claim 2 in which;
(i) the polymer is a vinyl acetate homopolymer, or a vinyl acetate-ethylene copolymer; and/or
(ii) the organosilane moiety is 3-glycidyloxypropyl silane.

17. The coating composition of claim 3 in which one or more of the following conditions apply:
i) at least one monomer is selected from alkenyl carboxylates;
ii) the protective colloid is a saponified or partially saponified polyvinyl alcohol with a degree of hydrolysis of from about 70 to about 100 mol %
iii) the organosilane moiety is a hydrophilic moiety comprising at least one group selected from hydroxyl, thiol, carboxyl, ester, epoxy, acyloxy, ketone, aldehyde, (meth)acryloxy and amino groups;
iv) the initiator is selected from inorganic peroxides, organic peroxides, peroxydicarbonates and azo compounds.

18. The coating composition of claim 3 in which one or more of the following conditions apply:
i) there are two or more monomers, at least one monomer being an alkenyl carboxylate and at least one being another alkenyl carboxylate or an olefin;
ii) the organosilane moiety comprises an epoxy group or at least one hydroxyl group.

19. The coating composition of claim 3 in which one or more of the following conditions apply;
i) the silica content of the coating composition before it is allowed to dry is of from about 0.01 to about 5 wt %;
ii) the amount of protective colloid, based on the total amount of protective colloid plus monomer, is of from about 1 to about 30 wt %;
iii) the amount of polymer in the aqueous polymer dispersion and/or in the undried coating composition is of from about 20 to about 80 wt %;
iv) the Tg of the polymer in the aqueous polymer dispersion is of from about −25 to about +45° C.;
v) the VOC content of the undried coating composition is less than about 5000 ppm;
vi) the volume-based median particle size of the polymer particles or droplets in the aqueous polymer dispersion is less than about 1.5 μm.

20. The coating composition of claim 3 in which;
(i) the polymer is a vinyl acetate homopolymer, or a vinyl acetate-ethylene copolymer; and/or
(ii) the organosilane moiety is 3-glycidyloxypropyl silane.
